(19) United States
(12) Patent Application Publication
(10) Pub. No.: US 2025/0109696 A1
(43) Pub. Date: Apr. 3, 2025

(54) Gas Turbine Exhaust Diffuser Horizontal Split Configuration

(71) Applicant: GE Infrastructure Technology LLC, Greenville, SC (US)

(72) Inventors: Robert Jamiolkowski, Warsaw (PL); Michal Badura, Warsaw (PL); Adam Wisniewski, Warsaw (PL)

(21) Appl. No.: 18/893,512

(22) Filed: Sep. 23, 2024

(30) Foreign Application Priority Data
Sep. 28, 2023 (PL) P.446257

(51) Int. Cl. F01D 25/30

(52) U.S. Cl. CPC F01D 25/30; F05D 2230/232

(57) ABSTRACT

Exhaust diffuser assemblies and gas turbines are provided. An exhaust diffuser assembly includes at least two diffuser segments coupled to one another and collectively forming an exhaust diffuser that extends from a forward end to an aft end. The at least two diffuser segments include a first diffuser segment of at least two diffuser segments having a first sleeve portion that extends to a first circumferential edge. The two diffuser segments further include a second diffuser segment having a second sleeve portion that extends to a second circumferential edge. The first circumferential edge is joined to the second circumferential edge at a split-line. A weld joint extends along a portion of the split-line to a weld end. The first sleeve portion and the second sleeve portion define a stress-relief opening disposed at least partially at the weld end of the weld joint.

### CROSS-REFERENCE TO RELATED APPLICATIONS

This application claims priority pursuant to 35 U.S.C. 119 (a) to Polish Patent Application No. P.446257, filed Sep. 28, 2023, which application is incorporated herein by reference in its entirety.

### FIELD OF THE INVENTION

The present disclosure relates generally to exhaust diffusers having one or more segments joined at a split-line. Particularly, the present disclosure relates to structures and openings that reduce localized stresses at the split-line.

### BACKGROUND

Turbomachines are utilized in a variety of industries and applications for energy transfer purposes. For example, a gas turbine engine generally includes a compressor section, a combustion section, a turbine section, and an exhaust section. The compressor section progressively increases the pressure of a working fluid entering the gas turbine engine and supplies this compressed working fluid to the combustion section. The compressed working fluid and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The combustion gases are then exhausted from the turbine section through an exhaust diffuser positioned downstream from the turbine section.

The exhaust diffuser typically includes an inner liner and an outer liner that is radially separated from the inner liner to form an exhaust flow passage through the diffuser. One or more generally airfoil shaped diffuser struts extend between the inner and outer liners within the exhaust flow passage to provide structural support to the outer liner and/or to an aft bearing that supports the shaft. The exhaust diffuser typically includes one or more segments (such as a top segment and a bottom segment) that are joined together at a split-line (e.g., via a weld joint).

Operation of the turbomachine for power generation can result in frequency oscillations (i.e., pressure pulsations or vibrations) within the exhaust diffuser that could cause damage over time to various components of the exhaust diffuser or result in an unscheduled or premature shutdown of the turbomachine. For example, the split-line may be exposed to these vibrations, which may damage the weld joint connecting the top segment and the bottom segment. Particularly, existing split-line designs may experience high stresses at the junctions between the top segment and the bottom segment as a result of operation of the turbomachine.

Accordingly, an improved exhaust diffuser, which has one or more structures and/or openings at the split-line that increase the robustness of the split-line to operational vibrations, is desired and would be appreciated in the art.

### SUMMARY OF THE INVENTION

Aspects and advantages of the exhaust diffuser assemblies and gas turbines in accordance with the present disclosure will be set forth in part in the following description, or may be obvious from the description, or may be learned through practice of the technology. In accordance with one embodiment, an exhaust diffuser assembly is provided. The exhaust diffuser assembly includes at least two diffuser segments coupled to one another and collectively forming an exhaust diffuser that extends from a forward end to an aft end. The at least two diffuser segments include a first diffuser segment of at least two diffuser segments having a first sleeve portion that extends to a first circumferential edge. The two diffuser segments further include a second diffuser segment having a second sleeve portion that extends to a second circumferential edge. The first circumferential edge is joined to the second circumferential edge at a split-line. A weld joint extends along a portion of the split-line to a weld end. The first sleeve portion and the second sleeve portion define a stress-relief opening disposed at least partially at the weld end of the weld joint.

In accordance with another embodiment, a gas turbine is provided. The gas turbine includes a compressor section, a combustion section downstream of the compressor section, and a turbine section downstream of the combustion section. The gas turbine section further includes an exhaust diffuser assembly having an exhaust diffuser downstream of the turbine section. The exhaust diffuser assembly includes at least two diffuser segments coupled to one another and collectively forming an exhaust diffuser that extends from a forward end to an aft end. The at least two diffuser segments include a first diffuser segment of at least two diffuser segments having a first sleeve portion that extends to a first circumferential edge. The two diffuser segments further include a second diffuser segment having a second sleeve portion that extends to a second circumferential edge. The first circumferential edge is joined to the second circumferential edge at a split-line. A weld joint extends along a portion of the split-line to a weld end. The first sleeve portion and the second sleeve portion define a stress-relief opening disposed at least partially at the weld end of the weld joint.

These and other features, aspects and advantages of the present exhaust diffuser assemblies and gas turbines will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present exhaust diffuser assemblies and gas turbines, including the best mode of making and using the present systems and methods, directed to one of ordinary skill in the art, is set forth in the specification, which makes reference to the appended figures, in which:

FIG. 1 is a schematic illustration of a turbomachine in accordance with embodiments of the present disclosure;

FIG. 2 schematically illustrates an enlarged cross-sectional view of an exhaust diffuser assembly in accordance with embodiments of the present disclosure;

FIG. 3 illustrates a cross-sectional, partially exploded view of an exhaust diffuser in accordance with embodiments of the present disclosure;

FIG. 4 illustrates a cross-sectional, assembled view of the exhaust diffuser shown in

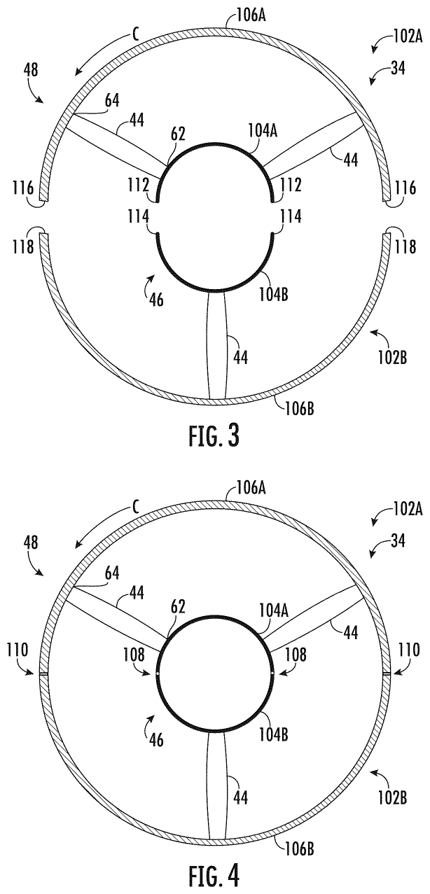

FIG. 3 in accordance with embodiments of the present disclosure;

FIG. 5 illustrates an isometric view of an exhaust diffuser assembly having an exhaust diffuser in accordance with embodiments of the present disclosure;

FIG. 6 illustrates an enlarged view of an exhaust diffuser of an exhaust diffuser assembly, which includes a split-line in accordance with embodiments of the present disclosure;

FIG. 7 illustrates an enlarged view of an exhaust diffuser of an exhaust diffuser assembly, which includes a split-line in accordance with another exemplary embodiment of the present disclosure;

FIG. 8 illustrates an enlarged view of an exhaust diffuser of an exhaust diffuser assembly having a connection block disposed at a split-line in accordance with embodiments of the present disclosure; and,

FIG. 9 illustrates a cross-sectional view of the exhaust diffuser assembly shown in FIG. 8 from along the line 9-9 in accordance with embodiments of the present disclosure.

### DETAILED DESCRIPTION

Reference now will be made in detail to embodiments of the present exhaust diffuser assemblies and gas turbines, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “fluid” may be a gas or a liquid. The term “fluid communication” means that two or more areas defining a flow passage are joined to one another such that a fluid is capable of making the connection (i.e., flowing) between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. Accordingly, the term “forward” generally refers to the compressor end of the gas turbine engine, while the term “aft” refers to the exhaust end of the gas turbine engine.

The term “radially” refers to the relative direction that is substantially perpendicular to an axial centerline of a particular component; the term “axially” refers to the relative direction that is substantially parallel and/or coaxially aligned to an axial centerline of a particular component; and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values, and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. The terms “directly coupled,” “directly fixed,” “directly attached to,” and the like mean that two components are joined in contact with one another and that no intermediate components or features are present.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “and/or” refers to a condition satisfied by any one of the following: A is true (or present) and B is false (or not present), A is false (or not present) and B is true (or present), and both A and B are true (or present).

Here and throughout the specification and claims, where range limitations are combined and interchanged, such ranges are identified and include all the sub-ranges contained therein unless context or language indicates otherwise. For example, all ranges disclosed herein are inclusive of the endpoints, and the endpoints are independently combinable with each other.

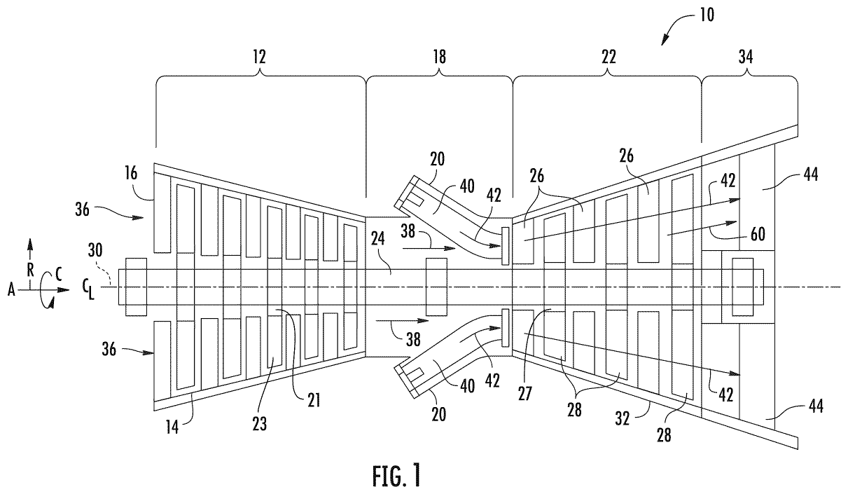

Referring now to the drawings, FIG. 1 illustrates a schematic diagram of one embodiment of a turbomachine, which in the illustrated embodiment is a gas turbine engine 10. Although an industrial or land-based gas turbine engine is shown and described herein, the present disclosure is not limited to an industrial and/or land-based gas turbine engine, unless otherwise specified in the claims. For example, the invention as described herein may be used in any type of turbomachine including but not limited to a steam turbine, an aircraft gas turbine, or a marine gas turbine.

As shown, the gas turbine engine 10 generally includes a compressor section 12. The compressor section 12 includes a compressor 14. The compressor section 12 includes an inlet 16 that is disposed at an upstream end of the gas turbine engine 10. The gas turbine engine 10 further includes a combustion section 18 having one or more combustors 20 disposed downstream from the compressor section 12. The gas turbine engine 10 further includes a turbine section 22 that is downstream from the combustion section 18. A shaft 24 extends generally axially through the gas turbine engine 10.

The compressor section 12 may generally include a plurality of rotor disks 21 and a plurality of rotor blades 23 extending radially outwardly from and connected to each rotor disk 21. Each rotor disk 21 in turn may be coupled to or form a portion of the shaft 24 that extends through the compressor section 12. The rotor blades 23 of the compressor section 12 may include turbomachine airfoils that define an airfoil shape (e.g., having a leading edge, a trailing edge, and side walls extending between the leading edge and the trailing edge). Additionally, the compressor section 12 includes stator vanes disposed between the rotor blades to define a series of compression stages. The stator vanes may extend from, and couple to, a compressor casing.

The turbine section 22 may generally include a plurality of rotor disks 27 and a plurality of rotor blades 28 extending radially outwardly from and being interconnected to each rotor disk 27. Each rotor disk 27 in turn may be coupled to or form a portion of the shaft 24 that extends through the turbine section 22. The turbine section 22 further includes an outer casing 32 that circumferentially surrounds the portion of the shaft 24 and the rotor blades 28. The turbine section 22 may include stationary nozzles 26 extending radially inward from the outer casing 32. The rotor blades 28 and stationary nozzles 26 may be arranged in alternating fashion in stages along an axial centerline 30 of gas turbine 10. Both the rotor blades 28 and the stationary nozzles 26 may include turbomachine airfoils that define an airfoil shape (e.g., having a leading edge, a trailing edge, and side walls extending between the leading edge and the trailing edge).

In operation, ambient air 36 or other working fluid is drawn into the inlet 16 of the compressor 14 and is progressively compressed to provide a compressed air 38 to the combustion section 18. The compressed air 38 flows into the combustion section 18 and is mixed with fuel to form a combustible mixture. The combustible mixture is burned within a combustion chamber 40 of the combustor 20, thereby generating combustion gases 42 that flow from the combustion chamber 40 into the turbine section 22. Energy (kinetic and/or thermal) is transferred from the combustion gases 42 to the rotor blades 28, causing the shaft 24 to rotate and produce mechanical work.

The gas turbine engine 10 may define a cylindrical coordinate system having an axial direction A extending along the axial centerline 30, a radial direction R perpendicular to the axial centerline 30, and a circumferential direction C extending around the axial centerline 30.

The combustion gases 42 exit the turbine section 22 and flow through the exhaust diffuser 34 across a plurality of struts 44 that are disposed within the exhaust diffuser 34. During various operating conditions of the gas turbine engine 10, such as during part-load operation, the combustion gases 42 flowing into the exhaust diffuser 34 from the turbine section 22 are conferred with a high level of swirl that is caused by the rotating turbine rotor blades 28. Such swirling flow can cause pressure fluctuations, frequency oscillations, or acoustic vibrations.

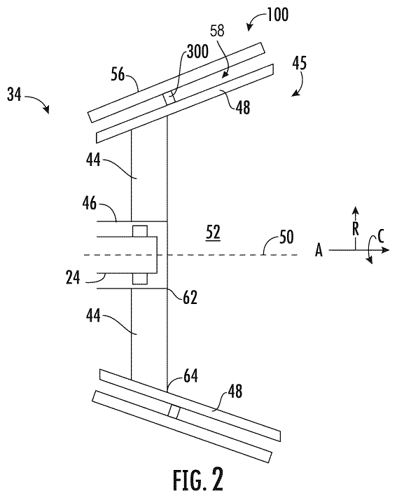

FIG. 2 illustrates a cross-sectional view of an exhaust diffuser assembly 100 (which includes an exhaust diffuser 34), in accordance with embodiments of the present disclosure. As shown, the exhaust diffuser 34 generally includes an inner liner 46 and an outer liner 48 radially spaced apart from the inner liner 46. The inner liner 46 may extend generally axially along an axial centerline 50 of the exhaust diffuser 34. The axial centerline 50 of the exhaust diffuser 34 may be coaxial with the axial centerline 30 of the gas turbine engine 10. The inner liner 46 is generally annular shaped and may at least partially surround rotating components. For example, the inner liner 46 may surround or encase a portion of the shaft 24.

In many embodiments, the outer liner 48 may be radially separated from the inner liner 46, such that an exhaust flow passage 52 is defined between the inner liner 46 and the outer liner 48. In particular embodiments, the inner liner 46 is concentrically and coaxially aligned within the outer liner 48 with respect to the axial centerline 50. In certain embodiments, a diffuser casing 56 may be radially spaced apart from the outer liner 48 and annularly surround the outer liner 48 such that a fluid plenum 58 is defined between the diffuser casing 56 and the outer liner 48. A flow of compressed air (or other working fluid) may flow within the fluid plenum 58 to cool the various components of the exhaust diffuser 34 (such as the outer liner 48 and the struts 44). A plurality of support links 300, which may be circumferentially spaced apart and disposed in the fluid plenum 58, connect the diffuser casing 56 to the outer liner 48. The present disclosure is not limited to any particular size, shape, material, or other physical characteristics of the inner liner 46, the outer liner 48, and/or the diffuser casing 56, except as recited in the claims.

Each of the diffuser struts 44 may extend between the inner liner 46 and the outer liner 48 and within the exhaust flow passage 52 defined therebetween. The diffuser struts 44 are spaced circumferentially around the inner liner 46, and the diffuser struts 44 may orient, align, or otherwise center the inner liner 46 within the outer liner 48. In addition, the diffuser struts 44 may provide structural support between the inner and the outer liners 46, 48. As shown in FIG. 1, the diffuser struts 44 are positioned relative to a direction of flow 60 of the spent combustion gases 42 flowing from the turbine section 22 of the gas turbine engine 10. As shown in FIG. 3, each diffuser strut 44 generally includes a root portion 62 that is connected to the inner liner 46 and a tip portion 64 radially separated from the root portion 62 and connected to the outer liner 48.

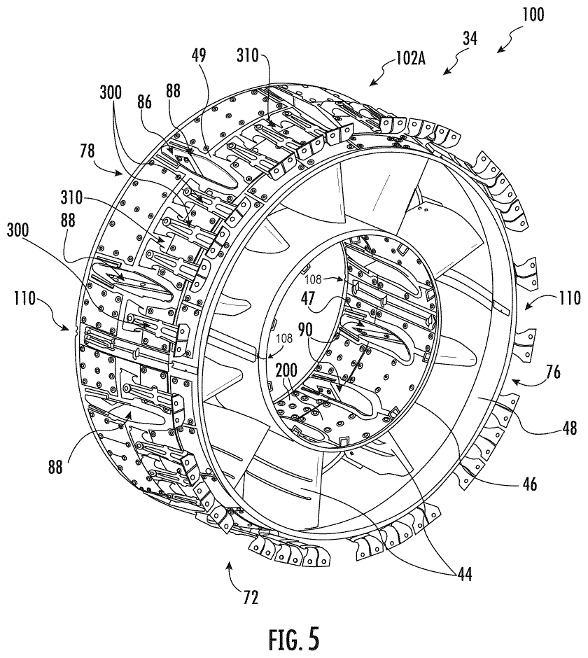

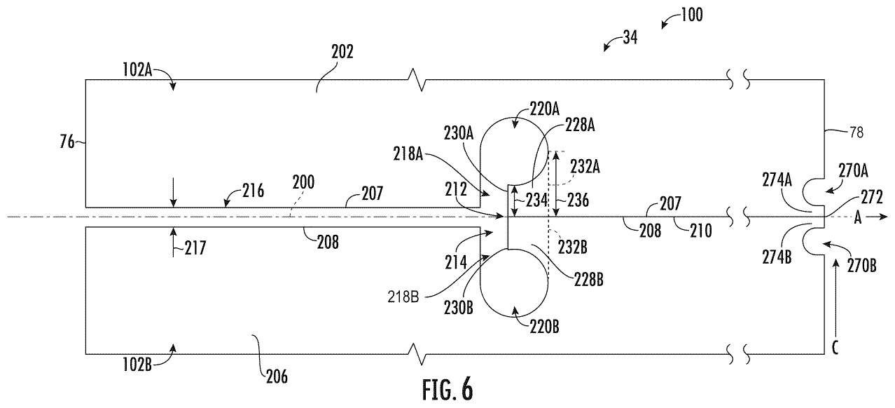

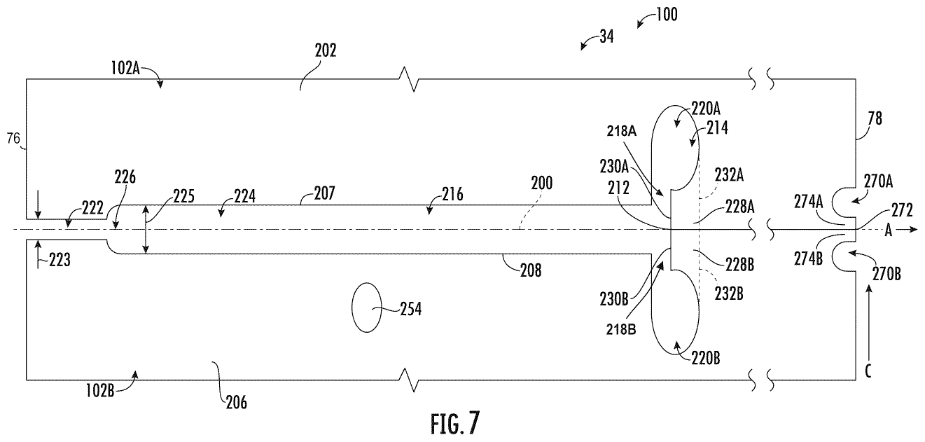

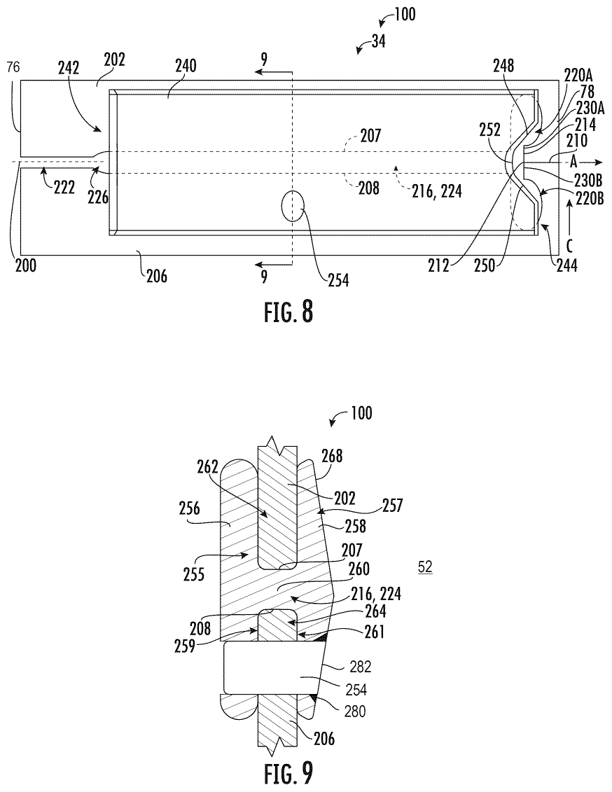

FIG. 3 illustrates a cross-sectional, partially exploded view of an exhaust diffuser 34, and FIG. 4 illustrates a cross-sectional, assembled view of the exhaust diffuser 34, in accordance with embodiments of the present disclosure. As shown, the exhaust diffuser 34 includes at least two diffuser segments 102A, 102B coupled to one another and collectively forming an exhaust diffuser 34. As shown, the at least two diffuser segments 102A, 102B may include a first diffuser segment 102A (or top diffuser segment) and a second diffuser segment 102B (or bottom diffuser segment).

While FIGS. 3 and 4 illustrate an exhaust diffuser 34 having two diffuser segments 102A, 102B, it should be appreciated that the exhaust diffuser 34 may have more than two diffuser segments joined together using similar structures and techniques described herein. The present disclosure should not be limited specifically to two diffuser segments unless specifically recited in the claims.

The at least two diffuser segments 102A, 102B may each include a sleeve portion, e.g., an inner sleeve portion 104A, 104B and an outer sleeve portion 106A, 106B. The inner sleeve portions 104A, 104B may be joined together at inner split-lines 108 to form the inner sleeve 46, and the outer sleeve portions 106A, 106B may be joined together at outer split-lines 110 to form the outer sleeve 48. Specifically, as shown, the first diffuser segment 102A may include a first inner sleeve portion 104A and a first outer sleeve portion 106A. Similarly, the second diffuser segment 102B may include a second inner sleeve portion 104B and a second outer sleeve portion 106B.

The first inner sleeve portion 104A may couple to the second inner sleeve portion 104B at inner split-lines 108, and the first outer sleeve portion 106A may couple to the second outer sleeve portion 106B at outer split-lines 110. More specifically, the first inner sleeve portions 104A may each extend circumferentially between first inner circumferential edges 112, and the second inner sleeve portion 104B may extend circumferentially between second inner circumferential edges 114. The first inner circumferential edges 112 may each be joined to a respective second inner circumferential edge 114 at the inner split-lines 108. Similarly, the first outer sleeve portions 106A may each extend circumferentially between first outer circumferential edges 116, and the second outer sleeve portion 106B may extend circumferentially between second outer circumferential edges 118. The first outer circumferential edges 116 may each be joined to a respective second outer circumferential edge 118 at the outer split-lines 110.

FIG. 5 illustrates an isometric view of an exhaust diffuser assembly 100 having an exhaust diffuser 34. As discussed above, the exhaust diffuser 34 may include an inner liner 46, an outer liner 48, and a plurality of struts 44 extending (e.g., radially) between the inner liner 46 and the outer liner 48. The exhaust diffuser 34 may include the first diffuser segment 102A and a second diffuser segment 102B, which are joined together at inner split-lines 108 and outer split-lines 110. Additionally, the exhaust diffuser 34 may extend axially between a forward end 76 and an aft end 78.

As shown in FIG. 5, a plurality of support link assemblies 300 are affixed to the outer liner 48, some of which are arranged in circumferential groups 310 (e.g., groups of three). Each support link assembly 300 in a group 310 of support link assemblies 300 may be approximately (e.g., +5%) circumferentially equally spaced from the other support link(s) 300 in the group 310. As shown in FIG. 5, each strut 44 of the plurality of struts 44 defines an interior 86 that extends between an outer opening 88 defined in the outer liner 48 and an inner opening 90 defined in the inner liner 46. In such embodiments, the support link assemblies 300 that are affixed to the outer liner 48 may be disposed between circumferentially neighboring outer openings 88. Particularly, one or more groups 310 may be disposed circumferentially between two neighboring outer openings 88. Additionally, a single split-line support link assembly 300 may be disposed between the outer split-line 110 and an outer opening 88 in closest proximity to the outer split-line 110. Although the circumferential groups 310 are shown as having three support link assemblies 300, other numbers of support link assemblies 300 may be used (e.g., two or more).

Referring now to FIGS. 6 and 7, an enlarged view of an exhaust diffuser 34 of an exhaust diffuser assembly 100 having a split-line 200 (which may be an inner split-line 108 or an outer split-line 110 discussed above with reference to FIGS. 4 and 5) is illustrated in accordance with embodiments of the present disclosure. As shown, the exhaust diffuser 34 may include at least two diffuser segments 102A, 102B coupled to one another and collectively forming the exhaust diffuser 34 that extends from a forward end 76 to an aft end 78. The at least two diffuser segments 102A, 102B may include a first diffuser segment 102A of at least two diffuser segments having a first sleeve portion 202 that extends to a first circumferential edge 207. The first sleeve portion 202 may be one of the first inner sleeve 104A and/or the first outer sleeve 106A discussed above with reference to FIGS. 3 and 4.

Additionally, the at least two diffuser segments 102A, 102B may further include a second diffuser segment 102B having a second sleeve portion 206 that extends to a second circumferential edge 208. The first circumferential edge 207 may be joined to the second circumferential edge 208 at the split-line 200. For example, a weld joint 210 may extend along a portion of the split-line 200 from a first (or forward) weld end 212 to a second (or aft) weld end 272. Additionally, the first sleeve portion 202 and the second sleeve portion 206 may define a forward stress-relief opening 214 disposed at least partially at the first weld end 212. The forward stress-relief opening 214 may extend from the forward end 76 of the exhaust diffuser 34 to (and partially beyond) the first weld end 212 of the weld joint 210.

The split-line 200 may be an imaginary (although at least partially visible at the weld joint 210), axially extending line that is defined at the junction between the first sleeve portion 202 and the second sleeve portion 206. In exemplary embodiments, the forward stress-relief opening 214 includes a slot portion 216 extending along the split-line 200 from the forward end 76 of the exhaust diffuser 34. The first circumferential edge 207 may be spaced apart from the second circumferential edge 208 to define the slot portion 216, such that the first circumferential edge 207 and the second circumferential edge 208 collectively define the slot portion 216. In other words, the slot portion 216 may be defined along a forward portion of the exhaust diffuser between the first circumferential edge 207 and the second circumferential edge 208 and along the split-line 200.

In some embodiments, as shown in FIGS. 6 and 7, the forward stress-relief opening 214 may include a branch portion 218A, 218B and a body portion 220A, 220B. The branch portion 218A, 218B may extend (generally perpendicularly) from the slot portion 216 to the body portion 220A, 220B. Specifically, the first sleeve portion 202 may define the first branch portion 218A extending generally perpendicularly from the slot portion 216 at the first weld end 212 of the weld joint 210 to the first body portion 220A. Similarly, the second sleeve portion 206 may define the second branch portion 218B extending from the slot portion 216 at the first weld end 212 of the weld joint 210 to the second body portion 220B.

The first body portion 220A and the second body portion 220B may each be spaced apart from the weld joint 210 and may extend axially alongside a forward portion of the weld joint 210. As shown, the first body portion 220A and the second body portion 220B may each be shaped as a circle or an oval in exemplary embodiments. However, in other embodiments, the first body portion 220A and the second body portion 220B may have any suitable shape (such as a rectangle, square, triangle, or other polygonal shape). In embodiments, the first body portion 220A and the second body portion 220B are congruent shapes arranged symmetrically about the split-line 200. As shown in FIG. 6, each of the first body portion 220A and the second body portion 220B may be shaped as a circle, and the branch portions 218A, 218B may be tangential to the respective circular shaped body portion. For example, the first branch portion 218A may be tangential to a forwardmost side of the first body portion 220A, and the second branch portion 218B may be tangential to a forwardmost side of the second body portion 220B. In this way, the first body portion 220A and the second body portion 220B may extend axially aft of the first branch portion 218A and the second branch portion 218B.

For example, at least one of (such as both of) the first sleeve portion 202 and the second sleeve portion 206 includes a tab 228A, 228B (e.g., forward tabs) defined between the stress-relief opening 214 and the weld joint 210. Specifically, the first sleeve portion 202 may define a first tab 228A between the forward stress relief opening 214 and the weld joint 210, and the second sleeve portion 206 may define a second tab 228B between the forward stress relief opening 214 and the weld joint 210.

Each of the tabs 228A, 228B may extend axially from an end wall 230A, 230B at the first weld end 212 of the weld joint 210 to a base 232A, 232B at an axially terminal end of the forward stress relief opening 214 (as indicated by the dashed line). For example, the first tab 228A may extend (e.g., axially) from the first end wall 230A to the first base 232A, and the second tab 228B may extend (e.g., axially) from the second end wall 230B to the second base 220B. The first end wall 230A and the second end wall 230B may be generally perpendicular to the split line 200 and may align with one another (e.g., in the axial direction), such that the first end wall 230A and the second end wall 230B form a single continuous surface (which may be flush or without bumps/protrusions).

In exemplary embodiments, each of the tabs 228A, 228B may diverge in width as the tab 228A, 228B extends axially from the respective end wall 230A, 230B at the first weld end 212 of the weld joint 210 to the base 232A, 232B. For example, each of the tabs 228A, 228B may define a first width 234 at the end wall 230A, 230B and a second width 236 at the base 232A, 232B. The first width 234 may be defined between the weld joint 210 and the forward stress relief opening 214 (specifically the body portion 220A, 220B) at the end wall 230A, 230B. The second width 236 may be defined between the weld joint 210 and the forward stress relief opening 214 (specifically the aft end of the body portion 220A, 220B) at the base 232A, 232B. The second width 236 may be larger than the first width 234 (such as greater than 20% larger, or such as greater than 50% larger). Each of the tabs 228A, 228B may increase in width from the first width 234 to the second width 236 as the tabs extend axially from the end wall 230A, 230B to the base 232A, 232B.

As shown in FIG. 6, the slot portion 216 may have a uniform width 217 in the circumferential direction C of the gas turbine 10 between the forward end 76 and the branch portions 218A, 218B. However, in some embodiments, as shown in FIG. 7, the slot portion 216 may have a varying width between the forward end 76 and the branch portions 218A, 218B. Specifically, as shown in FIG. 7, the slot portion 216 may include a first segment 222 having first width 223, a second segment 224 having a second width 225 that is larger than the first width 223, and a tapering segment 226 that tapers between the second width 225 and the first width 223. The first segment 222 may extend along the split-line 200 from the forward end 76 to the tapering segment 226. The tapering segment 226 may extend along the split-line 200 from the first segment 222 to the second segment 224. The second segment 224 may extend along the split-line 200 from the tapering segment 226 to the branch portions 218A, 218B.

As shown in FIGS. 6 and 7, in addition to the forward stress relief opening 214, the exhaust diffuser assembly 100 may include aft stress-relief openings 270A, 270B at the aft end 78. The weld joint 210 may extend continuously along the split-line 200 from the first weld end 212 to an aft end 272 of the weld joint 210. As shown, a first aft stress-relief opening 270A may be defined in the first sleeve portion 202, and a second aft stress-relief opening 270B may be defined in the second sleeve portion 206. The aft stress-relief openings 270A, 270B may each define aft tabs 274A, 274B. The first aft tab 274A may be defined between the weld joint 210, the aft end 78, and the first aft stress relief opening 270A.

Similarly, the second aft tab 274B may be defined between the weld joint 210, the aft end 78, and the second aft stress relief opening 270B. The aft stress-relief openings 270A, 270B may each converge in width as the tabs extend axially, which may advantageously reduce the stress at the weld joint 210. In exemplary embodiments, as shown, the aft stress-relief openings 270A, 270B may be shaped as semi-circles or semi-ovals, but the aft stress-relief openings 270A, 270B may have other shapes in other embodiments.

Referring now to FIG. 8, an enlarged view of an exhaust diffuser 34 of an exhaust diffuser assembly 100 having a split-line 200 (which may be an inner split-line 108 or an outer split-line 110 discussed above with reference to FIGS. 4 and 5) is illustrated in accordance with embodiments of the present disclosure. Particularly, FIG. 8 may be the same embodiment shown and described with reference to FIG. 7, but the embodiment shown in FIG. 8 includes a connection block 240 positioned in the slot portion 216 and coupled to the first sleeve portion 202 and the second sleeve portion 206.

The connection block 240 may extend axially between a first (or forward) end 242 and a second (or aft) end 244. The connection block 240 may be longest in the axial direction A, and the connection block 240 may extend within the slot 216, such that a first portion of the connection block 240 is disposed on a radially inward surface of the exhaust diffuser 34 and a second portion of the connection block 240 is disposed on a radially outward surface of the exhaust diffuser 34. For example, the connection block 240 may extend within the second segment 224 of the slot 216 (and/or at least partially within the tapering segment 226 in some embodiments). Additionally, the connection block 240 may at least partially overlap with one or more portions of the stress relief opening 214. For example, as shown, the connection block 240 may overlap with (e.g., entirely overlap with) the second segment 224 of the slot 216. Additionally, the connection block 240 may at least partially overlap with body portions 220A, 220B of the forward stress-relief opening 214.

As shown in FIG. 8, the connection block 240 may include a V-shaped opening at the second end 244. The V-shaped opening may be defined by a first slanted wall 248 and a second slanted wall 250, which may both extend to a junction or apex 252 where the first slanted wall 248 and the second slanted wall 250 connect. The apex 252, which is positioned at a peak of a curved interface between the first slanted wall 248 and the second slanted wall 250, may be positioned along the split-line 200 in many embodiments. The first slanted wall 248 and the second slanted wall 250 may be slanted with respect to the axial direction A, the split-line 200, and the walls from which the first and second slanted walls 248, 250 extend. The apex 252 may be axially spaced apart from the end walls 230A, 230B, which advantageously allows the weld joint 210 to be accessed and welded up from the aft end 78 to the first weld end 212 without having to disconnect the connection block 240. Additionally, as will be discussed below in more detail, a dowel pin 254 may extend through the connection block 240 and through the second sleeve portion 206 to couple the connection block 240 with the second sleeve portion 206 and to align the connection block 240 within the slot portion 216.

Referring now to FIG. 9, a cross-sectional view of the exhaust diffuser assembly 100 from along the line 9-9 is illustrated in accordance with embodiments of the present disclosure. As shown, the connection block 240 may include a first wall 256 disposed on (e.g., in contact with) a first exterior side 255 of the first sleeve portion 202 and a second exterior side 259 of the second sleeve portion 206. Additionally, the connection block 240 may include a second wall 258 disposed on (e.g., in contact with) a first interior side 257 of the first sleeve portion 202 and a second interior side 261 of the second sleeve portion 206. Further, the connection block 240 may include a cross-bar 260 that extends through the slot 216. Particularly, the cross-bar 260 may extend through the second segment 224 of the slot 216 from the first wall 256 to the second wall 258, thereby providing the connection block 240 with a generally H-shaped cross-section. The first wall 256 and the second wall 258 may be generally perpendicular to the cross-bar 260. Additionally, as shown, the dowel pin 254 may extend through the first wall 256, the second sleeve portion 206, and the second wall 258. The dowel pin 254 may extend fully through the first wall 256 and/or the second wall 258, such that a respective terminal end of the dowel pin 254 extends outwardly from at least one of the first wall 256 and the second wall 258. Alternately, the dowel pin 254 may extend partially through the first wall 256 and the second wall 258 (i.e., the dowel pin 254 may terminate within the first wall 256 and the second wall 258). In many embodiments, the dowel pin 254 may be welded on one or both ends to the connection block 240. For example, the dowel pin 254 may be welded to the second wall 258 of the connection block 240 via a weld joint 280 (which may be annular about the dowel pin 254). Furthermore, as shown in FIG. 9, the dowel pin 254 may include a slanted end 282 that is flush with the arcuate exterior wall 268, which increases the aerodynamic efficiency of the connection block 240. The slanted end 282 may be ground flush to the arcuate exterior wall 260 (e.g., with a grinder or other means).

In exemplary embodiments, as shown, the connection block 240 may define a first channel 262 and a second channel 264. The first channel 262 may be defined between the first wall 256 and the second wall 258 on a first side of the cross-bar 260. The second channel 264 may be defined between the first wall 256 and the second wall 258 on a second side of the cross-bar 260. Each of the first channel 262 and the second channel 264 has a U-shaped cross-section. The first sleeve portion 202 may extend into the first channel 262, and the second sleeve portion 206 may extend into the second channel 264.

The second wall 258 of the connection block 240 may be positioned within the flow of exhaust gases (e.g., within the exhaust flow passage 52 discussed above with reference to FIG. 2). In such embodiments, the second wall 258 may include an arcuate exterior wall 268, which may include a first tapered side and a second tapered side each extending to an apex. The arcuate exterior wall 268 may advantageously increase the aerodynamic efficiency of the exhaust diffuser 34 by preventing flow vortices that may otherwise be caused by an object in the exhaust flow passage 52.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

An exhaust diffuser assembly comprising: at least two diffuser segments coupled to one another and collectively forming an exhaust diffuser that extends from a forward end to an aft end, the at least two diffuser segments comprising: a first diffuser segment of at least two diffuser segments having a first sleeve portion that extends to a first circumferential edge; and a second diffuser segment having a second sleeve portion that extends to a second circumferential edge, the first circumferential edge joined to the second circumferential edge at a split-line; wherein a weld joint extends along a portion of the split-line to a weld end, and wherein the first sleeve portion and the second sleeve portion define a stress-relief opening disposed at least partially at the weld end of the weld joint.

The exhaust diffuser assembly as in any preceding clause, wherein at least one of the first sleeve portion and the second sleeve portion includes a tab defined between the stress-relief opening and the weld joint; and wherein the tab diverges in width as the tab extends axially from an end wall at the weld end of the weld joint to a base of the tab.

The exhaust diffuser assembly as in any preceding clause, wherein the weld end is a first weld end disposed between the forward end and the aft end of the exhaust diffuser; and wherein the stress-relief opening includes a slot portion extending along the split-line from the forward end of the exhaust diffuser to the first weld end.

The exhaust diffuser assembly as in any preceding clause, wherein the stress-relief opening further comprises a body portion spaced apart from the weld joint and extending axially alongside the first weld end of the weld joint.

The exhaust diffuser assembly as in any preceding clause, wherein the body portion includes a symmetrical round shape.

The exhaust diffuser assembly as in any preceding clause, wherein the body portion includes one of a circular shape or an oval shape.

The exhaust diffuser assembly as in any preceding clause, wherein the slot portion includes a first segment having a first width and a second segment having a second width, the second width being larger than the first width.

The exhaust diffuser assembly as in any preceding clause, wherein the first circumferential edge and the second circumferential edge are spaced apart from one another to define the slot portion.

The exhaust diffuser assembly as in any preceding clause, further comprising a connection block disposed in the slot portion and coupled to the first sleeve portion and the second sleeve portion.

The exhaust diffuser assembly as in any preceding clause, the connection block comprising a first wall disposed on a first exterior side of the first sleeve portion and a second exterior side of the second sleeve, a cross bar extending through the slot, and a second wall disposed on a first interior side of the first sleeve portion and a second interior side of the second sleeve portion.

The exhaust diffuser assembly as in any preceding clause, wherein the connection block defines a first channel and a second channel, wherein the first sleeve portion extends into the first channel, and wherein the second sleeve portion extends into the second channel.

The exhaust diffuser assembly as in any preceding clause, wherein the stress-relief opening is a first stress-relief opening; wherein the weld joint extends to a second weld end at the aft end of the exhaust diffuser; and wherein a second stress-relief opening is disposed at the aft end of the exhaust diffuser proximate to the second weld end.

The exhaust diffuser assembly as in any preceding clause, wherein the second stress-relief opening includes a partially round shape.

The exhaust diffuser assembly as in any preceding clause, wherein the second stress-relief opening includes a semi-circular shape or a half stadium shape.

A gas turbine comprising: a compressor section; a combustion section downstream of the compressor section; a turbine section downstream of the combustion section; and an exhaust diffuser assembly having an exhaust diffuser downstream of the turbine section, the exhaust diffuser assembly comprising: at least two diffuser segments coupled to one another and collectively forming an exhaust diffuser that extends from a forward end to an aft end, the at least two diffuser segments comprising: a first diffuser segment of at least two diffuser segments having a first sleeve portion that extends to a first circumferential edge; and a second diffuser segment having a second sleeve portion that extends to a second circumferential edge, the first circumferential edge joined to the second circumferential edge at a split-line; wherein a weld joint extends along a portion of the split-line to a weld end, and wherein the first sleeve portion and the second sleeve portion define a stress-relief opening disposed at least partially at the weld end of the weld joint.

The gas turbine as in any preceding clause, wherein at least one of the first sleeve portion and the second sleeve portion includes a tab defined between the stress-relief opening and the weld joint; and wherein the tab diverges in width as the tab extends axially from an end wall at the weld end of the weld joint to a base of the tab.

The gas turbine as in any preceding clause, wherein the weld end is a first weld end disposed between the forward end and the aft end of the exhaust diffuser; and wherein the stress-relief opening includes a slot portion extending along the split-line from the forward end of the exhaust diffuser to the first weld end.

The gas turbine as in any preceding clause, wherein the stress-relief opening further comprises a body portion spaced apart from the weld joint and extending axially alongside the first weld end of the weld joint.

The gas turbine as in any preceding clause, wherein the slot portion includes a first segment having a first width and a second segment having a second width, the second width being larger than the first width.

The gas turbine as in any preceding clause, wherein the first circumferential edge and the second circumferential edge are spaced apart from one another to define the slot portion.

The gas turbine as in any preceding clause, further comprising a connection block disposed in the slot portion and coupled to the first sleeve portion and the second sleeve portion.

The gas turbine as in any preceding clause, the connection block comprising a first wall disposed on a first exterior side of the first sleeve portion and a second exterior side of the second sleeve, a cross bar extending through the slot, and a second wall disposed on a first interior side of the first sleeve portion and a second interior side of the second sleeve portion.

The gas turbine as in any preceding clause, wherein the connection block defines a first channel and a second channel, wherein the first sleeve portion extends into the first channel, and wherein the second sleeve portion extends into the second channel.

The gas turbine as in any preceding clause, wherein the stress-relief opening is a first stress-relief opening; wherein the weld joint extends to a second weld end at the aft end of the exhaust diffuser; and wherein a second stress-relief opening is disposed at the aft end of the exhaust diffuser proximate to the second weld end.

1. An exhaust diffuser assembly comprising:
at least two diffuser segments coupled to one another and collectively forming an exhaust diffuser that extends from a forward end to an aft end, the at least two diffuser segments comprising:
a first diffuser segment of at least two diffuser segments having a first sleeve portion that extends to a first circumferential edge; and
a second diffuser segment having a second sleeve portion that extends to a second circumferential edge, the first circumferential edge joined to the second circumferential edge at a split-line;
wherein a weld joint extends along a portion of the split-line to a weld end, and wherein the first sleeve portion and the second sleeve portion define a stress-relief opening disposed at least partially at the weld end of the weld joint.

2. The exhaust diffuser assembly as in claim 1, wherein at least one of the first sleeve portion and the second sleeve portion includes a tab defined between the stress-relief opening and the weld joint; and wherein the tab diverges in width as the tab extends axially from an end wall at the weld end of the weld joint to a base of the tab.

3. The exhaust diffuser assembly as in claim 1, wherein the weld end is a first weld end disposed between the forward end and the aft end of the exhaust diffuser; and wherein the stress-relief opening includes a slot portion extending along the split-line from the forward end of the exhaust diffuser to the first weld end.

4. The exhaust diffuser assembly as in claim 3, wherein the stress-relief opening further comprises a body portion spaced apart from the weld joint and extending axially alongside the first weld end of the weld joint.

5. The exhaust diffuser assembly as in claim 3, wherein the slot portion includes a first segment having a first width and a second segment having a second width, the second width being larger than the first width.

6. The exhaust diffuser assembly as in claim 3, wherein the first circumferential edge and the second circumferential edge are spaced apart from one another to define the slot portion.

7. The exhaust diffuser assembly as in claim 3, further comprising a connection block disposed in the slot portion and coupled to the first sleeve portion and the second sleeve portion.

8. The exhaust diffuser assembly as in claim 7, the connection block comprising a first wall disposed on a first exterior side of the first sleeve portion and a second exterior side of the second sleeve, a cross bar extending through the slot, and a second wall disposed on a first interior side of the first sleeve portion and a second interior side of the second sleeve portion.

9. The exhaust diffuser assembly as in claim 7, wherein the connection block defines a first channel and a second channel, wherein the first sleeve portion extends into the first channel, and wherein the second sleeve portion extends into the second channel.

10. The exhaust diffuser assembly as in claim 7, wherein the stress-relief opening is a first stress-relief opening; wherein the weld joint extends to a second weld end at the aft end of the exhaust diffuser; and wherein a second stress-relief opening is disposed at the aft end of the exhaust diffuser proximate to the second weld end.

11. A gas turbine comprising:
a compressor section;
a combustion section downstream of the compressor section;
a turbine section downstream of the combustion section; and
an exhaust diffuser assembly having an exhaust diffuser downstream of the turbine section, the exhaust diffuser assembly comprising:
at least two diffuser segments coupled to one another and collectively forming an exhaust diffuser that extends from a forward end to an aft end, the at least two diffuser segments comprising:
a first diffuser segment of at least two diffuser segments having a first sleeve portion that extends to a first circumferential edge; and
a second diffuser segment having a second sleeve portion that extends to a second circumferential edge, the first circumferential edge joined to the second circumferential edge at a split-line;
wherein a weld joint extends along a portion of the split-line to a weld end, and wherein the first sleeve portion and the second sleeve portion define a stress-relief opening disposed at least partially at the weld end of the weld joint.

12. The gas turbine as in claim 11, wherein at least one of the first sleeve portion and the second sleeve portion includes a tab defined between the stress-relief opening and the weld joint; and wherein the tab diverges in width as the tab extends axially from an end wall at the weld end of the weld joint to a base of the tab.

13. The gas turbine as in claim 11, wherein the weld end is a first weld end disposed between the forward end and the aft end of the exhaust diffuser; and wherein the stress-relief opening includes a slot portion extending along the split-line from the forward end of the exhaust diffuser to the first weld end.

14. The gas turbine as in claim 13, wherein the stress-relief opening further comprises a body portion spaced apart from the weld joint and extending axially alongside the first weld end of the weld joint.

15. The gas turbine as in claim 13, wherein the slot portion includes a first segment having a first width and a second segment having a second width, the second width being larger than the first width.

16. The gas turbine as in claim 13, wherein the first circumferential edge and the second circumferential edge are spaced apart from one another to define the slot portion.

17. The gas turbine as in claim 13, further comprising a connection block disposed in the slot portion and coupled to the first sleeve portion and the second sleeve portion.

18. The gas turbine as in claim 17, the connection block comprising a first wall disposed on a first exterior side of the first sleeve portion and a second exterior side of the second sleeve, a cross bar extending through the slot, and a second wall disposed on a first interior side of the first sleeve portion and a second interior side of the second sleeve portion.

19. The gas turbine as in claim 17, wherein the connection block defines a first channel and a second channel, wherein the first sleeve portion extends into the first channel, and wherein the second sleeve portion extends into the second channel.

20. The gas turbine as in claim 17, wherein the stress-relief opening is a first stress-relief opening; wherein the weld joint extends to a second weld end at the aft end of the exhaust diffuser; and wherein a second stress-relief opening is disposed at the aft end of the exhaust diffuser proximate to the second weld end.
